(19) United States
(12) Patent Application Publication
(10) Pub. No.: US 2021/0207888 A1
(43) Pub. Date: Jul. 8, 2021

(54) FIRING SETTER

(71) Applicant: Alan Devoe, La Jolla, CA (US)

(72) Inventor: Alan Devoe, La Jolla, CA (US)

(21) Appl. No.: 15/986,227

(22) Filed: May 22, 2018

Related U.S. Application Data
(60) Provisional application No. 62/510,125, filed on May 23, 2017.

(51) Int. Cl. F27D 5/00; B28B 3/00; B28B 11/24

(52) U.S. Cl. CPC F27D 5/0012; B28B 11/243; B28B 3/003

(57) ABSTRACT

A method of manufacturing a furnace setter is disclosed. The method includes placing one or more layers of ceramic tape on a form that has a shape corresponding to a desired shape of the furnace setter. The method further includes applying pressure to the assembly that includes the form and the tape layers. The application of pressure to the assembly compresses the ceramic tape layers together to generate an integrated body having the desired shape of the furnace setter. The method further includes removing the integrated body from the form and applying a heat treatment to the integrated body to generate the furnace setter as a sintered solid body. According to a further embodiment, a furnace setter is disclosed that has a weight to area ratio that is less than 10 g/in², less than 5 g/in², less than 3 g/in², or less than 2 g/in².

### RELATED APPLICATIONS

This application claims the benefit of U.S. Provisional Application 62/510,125 filed on May 23, 2017. The entire contents of this application is incorporated herein by reference in its entirety.

### FIELD OF THE INVENTION

This disclosure generally relates to support structures that house ceramic materials during heat treatment in an oven or kiln.

### BACKGROUND OF THE INVENTION

Processing of a ceramic material often includes subjecting the ceramic material to a heat treatment in a high temperature oven or kiln. Kilns have been used for thousands of years to transform objects made of clay into pottery, for example. Modern industrial processes also use kilns to process ceramic materials. In the electronics industry, for example, chip resistors, inductors, and capacitors are objects containing ceramic materials that require firing. In other industries, ceramic parts are used in mechanical applications, such as bushings. Many other modern applications also make use of ceramic parts, from ceramic buttons used in the clothing industry to ceramic objects (e.g., necklace beads) used in the jewelry industry.

The process of heat treating a ceramic material to transform its properties is called firing or sintering. During sintering, powdered material coalesces and becomes compacted into a solid or porous mass without melting. The resulting sintered material generally has increased density and enhanced material properties such as strength and thermal or electrical conductivity.

Objects to be fired are typically placed in a kiln and are supported within the kiln on various support structures called kiln furniture or setters. Kiln furniture may take the form of shelves, posts, racks, etc. Kiln furniture is constructed of refractory materials that are chemically and mechanically stable at high temperatures. Examples of common refractory materials include alumina (Al₂O₃) and silica (SiO₂), having melting points 2,072° C., and 1,713° C., respectively. Zirconia (ZrO²), silicon carbide (SiC), and magnesia (MgO) are examples of refractory materials that are used when the material must withstand extremely high temperatures, having melting points 2,715° C., 2,730° C., and 2,852° C., respectively.

The energy required to perform a particular heat treatment depends on the size and thermal properties of the kiln, the mass and thermal properties of the objects to fired, and the mass and thermal properties of the kiln furniture. Energy is expended to heat the kiln and its contents up to the firing temperature and to maintain the firing temperature during the firing process. A significant fraction of the energy expended during a heat treatment goes into heating the kiln furniture. Further, the physical size of kiln furniture limits the number of objects that may be fired at a given time. Thus, the greater the thermal mass and physical size of kiln furniture, the greater the energy consumption and the fewer objects that may be fired in a given firing operation.

### SUMMARY OF THE INVENTION

For at least the above considerations, it would be advantageous to reduce the thermal mass and physical size of kiln furniture to respectively reduce energy consumption and to allow more objects to be fired at a given time, thus increasing efficiency and throughput of firing operations. The disclosed embodiments provide a significant reduction in both size and thermal mass of firing setters, as described in greater detail below.

While the invention is described in connection with certain embodiments, it should be understood that the invention is not limited to these embodiments. On the contrary, the invention includes all alternatives, modifications and equivalents as may be included within the spirit and scope of the disclosed invention.

A method of manufacturing a furnace setter is disclosed. The method includes placing one or more layers of ceramic tape on a form that has a shape corresponding to a desired shape of the furnace setter. The method further includes applying pressure to the assembly that includes the form and the tape layers. The application of pressure to the assembly compresses the ceramic tape layers together to generate an integrated body having the desired shape of the furnace setter. The method further includes removing the integrated body from the form and applying a heat treatment to the integrated body to generate the furnace setter as a sintered solid body.

A furnace setter is disclosed that has a weight to area ratio that is less than 10 g/in², less than 5 g/in², less than 3 g/in², or less than 2 g/in². The furnace setter may have a thickness that is less than or equal to 0.03 inches and may include one or more of yttria stabilized zirconia (YSZ), aluminum oxide, barium titanate, barium neodymium titanate, magnesium oxide, titanium oxide, calcium zirconate, and magnesium zirconate. This list of ceramics is provided merely as an example of ceramics that may be used in various embodiments and should not be considered as limiting. In other embodiments, any other suitable ceramic may be used.

A furnace setter may have a shape that enables two or more setters to be stacked in a first relative orientation, having a first separation between stacked setters, and a second relative orientation, having a second separation between stacked setters. The furnace setter may have a shape including a flat rectangular section including rails on at least one pair of opposite sides of the rectangular section. In a further embodiment, the setter may have a shape, including complementary features in the rails, which enables two or more setters to be stacked in first, second, and third relative orientations, having corresponding first, second, and third separations between stacked setters.

A furnace setter is disclosed that has a base material and a coating material. The base material may include YSZ having a thickness less than or equal to 0.03 in. The coating material may have a thickness less than or equal to 0.002 in and may include one or more of aluminum oxide, barium titanate, barium neodymium titanate, magnesium oxide, titanium oxide, calcium zirconate, and magnesium zirconate.

The above and other objectives and advantages of the disclosed invention are described in detail below with reference to the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, explain the principles of the invention.

FIG. 1 is an isometric view depicting examples of firing setters.

FIG. 2 is an isometric view depicting an example placement of ceramic objects on a firing setter.

FIG. 3 is an isometric view depicting an example configuration of stacked setters in a kiln.

FIG. 4 is an isometric view depicting an example of improved firing setters in a dis-assembled configuration, according to an embodiment.

FIG. 5A is an isometric view depicting an example of improved firing setters similar to those of FIG. 4 in an assembled configuration, according to an embodiment.

FIG. 5B is a cross sectional view of the stacked setters of FIG. 5A, according to an embodiment.

FIG. 6 illustrates a piece of ceramic tape used in a method of manufacturing the improved setters of FIGS. 4 and 5, according to an embodiment.

FIG. 7 is a perspective view illustrating materials used in a method of manufacturing the improved setters of FIGS. 4 and 5, according to an embodiment.

FIG. 8A is a cross sectional view of the sheet of ceramic tape and form illustrated in FIG. 7, according to an embodiment.

FIG. 8B is a cross sectional view of a configuration in which several sheets of ceramic tape 600 are placed on the form, according to an embodiment.

FIG. 8C is a cross sectional view of a configuration in which pressure has been applied to sheets of ceramic tape on the form to generate an integrated body, according to an embodiment.

FIG. 8D is a cross sectional view of the resulting integrated body that has been removed from the form, according to an embodiment.

FIG. 9 shows a three-dimensional top-down view of a form 900 having different complementary features on opposite edges of a flat rectangular section, according to an embodiment.

FIG. 10 is a perspective view illustrating a dis-assembled configuration in which setters based on form of FIG. 9 may be arranged with three relative orientations, according to an embodiment.

FIG. 11 shows a three-dimensional top-down view of a form having six features, according to an embodiment.

FIG. 12 shows a setter manufactured based on the form of FIG. 11, according to an embodiment.

FIG. 13 shows a three-dimensional top-down cross-sectional view of a configuration in which setters based on form of FIG. 11 are arranged in a stacked configuration with a vertical gap between setters, according to an embodiment.

FIG. 14 illustrates a three-dimensional top-down view of a stacked configuration of setters based on the form 1100 of FIG. 11, according to an embodiment.

FIG. 15 is a flowchart illustrating a method of manufacturing an improved furnace setter, according to an embodiment.

### DETAILED DESCRIPTION

This disclosure provides systems and methods of generating firing setters having a significant reduction in both size and thermal mass relative to conventional firing setters. As such, the disclosed embodiments exhibit reduced energy consumption and enable more objects to be fired at a given time, thus increasing efficiency and throughput of firing operations.

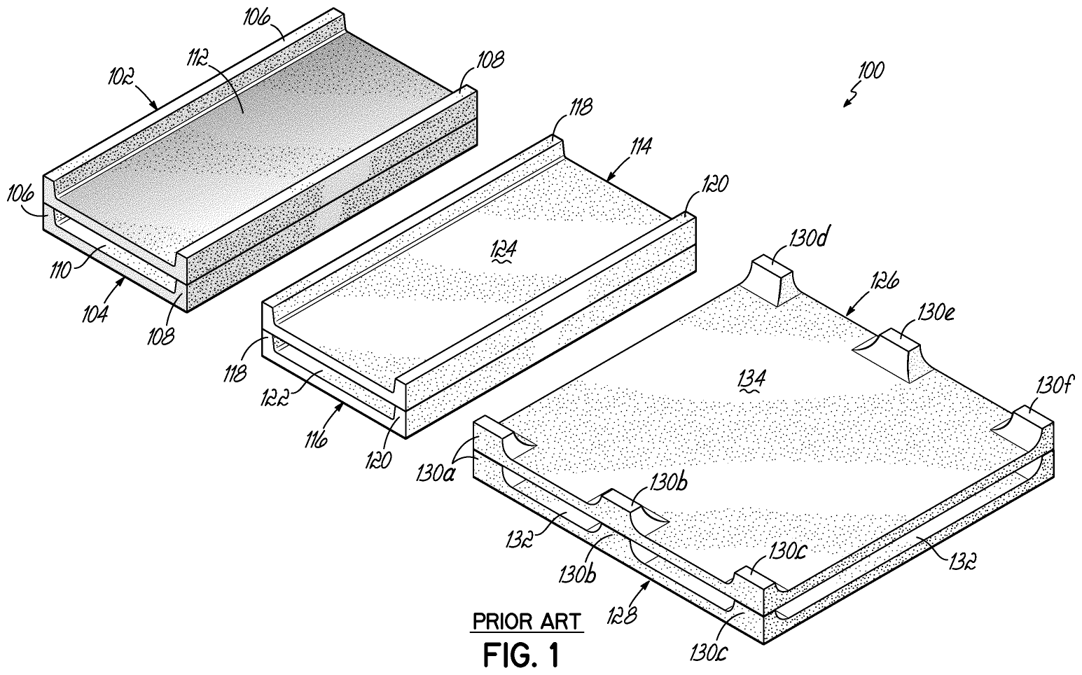

FIG. 1 is an isometric view 100 depicting examples of firing setters. In a first example, two firing setters, 102 and 104, made of zirconia are shown. Each of setters 102 and 104 has dimensions 4.5 in×2.375 in (i.e., total area 10.69 in²). Each of setters 102 and 104 has a pair of rails, 106 and 108. The presence of rails 106 and 108 allow setters 102 and 104 to be placed in a stacked configuration with a separation 110 between setters 102 and 104, as shown. Each of setters 102 and 104 has a usable area 112 between rails 106 and 108 having dimensions 4.5 in×1.875 in (i.e., 8.44 in²) where objects to be fired may be placed. Each of setters 102 and 104 weighs 180 g representing a total weight per total area of 16.84 g/in², and a weight per usable area of 21.33 g/in².

In a second example, two firing setters, 114 and 116, made of alumina are shown. Each of setters 114 and 116 has dimensions 4.5 in×2.376 in (i.e., total area 10.69 in²). Each of setters 114 and 116 has a pair of rails, 118 and 120. The presence of rails 118 and 120 allow setters 114 and 116 to be placed in a stacked configuration with a separation 122 between setters 114 and 116, as shown. Each of setters 114 and 116 has a usable area 124 between rails 118 and 120 having dimensions 4.5 in×1.876 in (i.e., 8.44 in²) where objects to be fired may be placed. Each of setters 114 and 116 weighs 128 g representing a total weight per total area of 11.98 g/in², and a weight per usable area of 15.17 g/in².

In a third example, two larger firing setters, 126 and 128, made of alumina are shown. Each of setters 126 and 128 has dimensions 5.94 in×5.875 in (i.e., total area 34.90 in²). Each of setters 126 and 128 has a plurality of posts 130a, 130b, 130c, 130d, 130e, and 130f. The presence of posts 130a, 130b, 130c, 130d, 130e, and 130f allow setters 126 and 128 to be placed in a stacked configuration with a separation 132 between setters 126 and 128, as shown. Each of setters 126 and 128 has a usable area 134 between posts 130a, 130b, 130c, 130d, 130e, and 130f having dimensions 5.5 in×5.25 in (i.e., 28.88 in²) where objects to be fired may be placed. Each of setters 126 and 128 weighs 307 g representing a total weight per total area of 8.8 g/in², and a weight per usable area of 10.63 g/in².

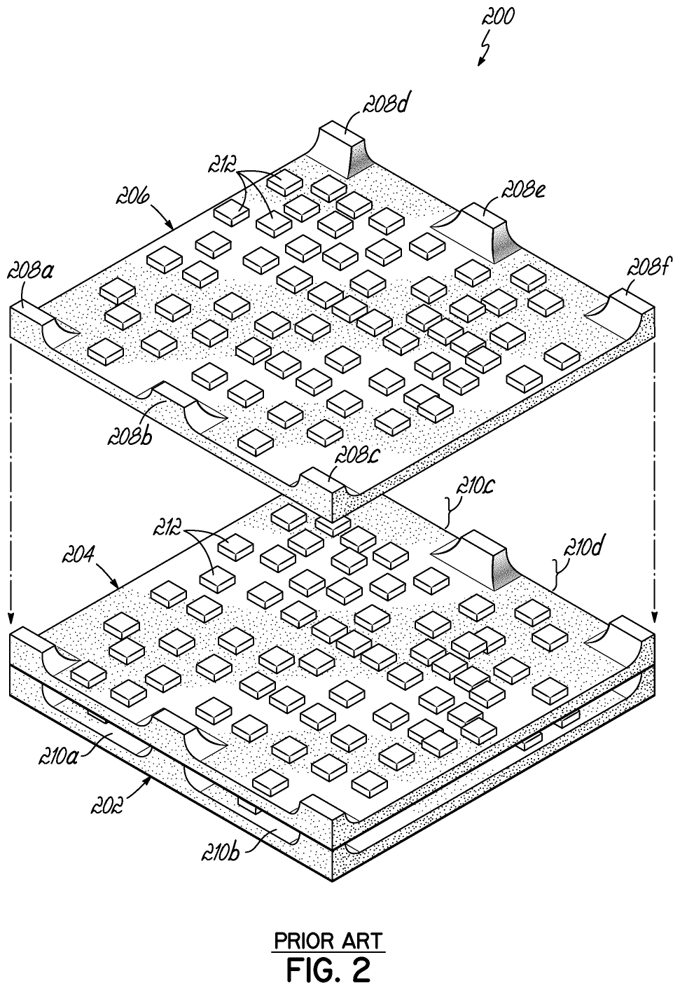

FIG. 2 is an isometric view 200 depicting an example placement 200 of ceramic objects on a firing setter. In this example, three setters, 202, 204, and 206 are shown in a stacked configuration. Setters 202, 204, and 206 are similar to the larger alumina setters 126 and 128 of FIG. 1. Each of setters 202, 204, and 206 contain a plurality of posts 208a, 208b, 208c, 208d, 208e, and 208f, that are similar to posts 130a, 130b, 130c, 130d, 130e, and 130f of FIG. 1. Posts 208a, 208b, 208c, 208d, 208e, and 208f, allow setters such as 202, 204, and 206 to be positioned in a stacked configuration such that gaps 210a and 210b are formed between setters 202 and 204, and gaps 210c and 210d are formed between setters 204 and 206.

A plurality of ceramic objects 212 may be placed on a usable area of each setter. In this example, objects 212 are shown placed on a useable area of setter 206. Similarly, a plurality of objects may be placed on a useable area of setter 202 to reside in gaps 210a and 210b are formed between setters 202 and 204. Likewise, a plurality of objects may be placed on a useable area of setter 204 to reside in gaps 210c and 210d are formed between setters 204 and 206.

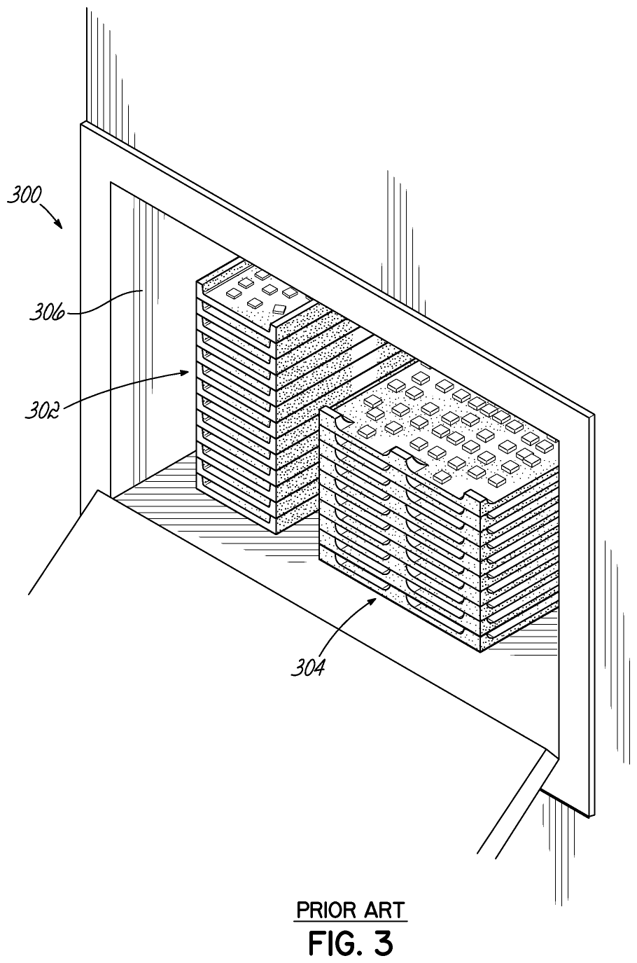

FIG. 3 is an isometric view 300 depicting an example configuration of stacked setters in a kiln. In this example a first stack 302 and a second stack 304 of setters are placed in an interior region 306 of a kiln. In this example, stack 302 contains 13 setters, and stack 304 includes 10 setters in a stacked configuration. As mentioned above, smaller setters would allow more setters to be placed in the kiln and would thus improve throughput of kiln firing operations. The height of the rails (e.g., see FIG. 1 rails 106, 108, 118, and 120) or posts (e.g., see FIG. 1, posts 130a-130f) of a setter determines the size of the air gap (e.g., see FIG. 1, air gaps 110, 122, and 132) and the overall height of a setter. In turn, the height of a setter determines the number of setters that may be stacked to fit within an interior 306 of a kiln.

In the example of FIG. 2, the plurality of objects 212 are capacitors each having a thickness of approximately 0.06-0.07 in. The setters 202, 204, and 206 each have an air gap (210a-210c) of approximately 0.3 in. Generally, the air gap needs to be only roughly 0.1 in for a proper heat treatment of objects 212 such as the capacitors in this example. Thus, the air gap (210a-210c) of setters 202, 204, and 206 is roughly three times the size needed for this application. Thus, using setters 202, 204, and 206 to fire objects 212, such as the capacitors in this example, wastes valuable kiln space. Further, as described above, setters having smaller thickness would have lower thermal mass and would reduce energy costs associated heat treatment of objects 212, such as the capacitors in this example

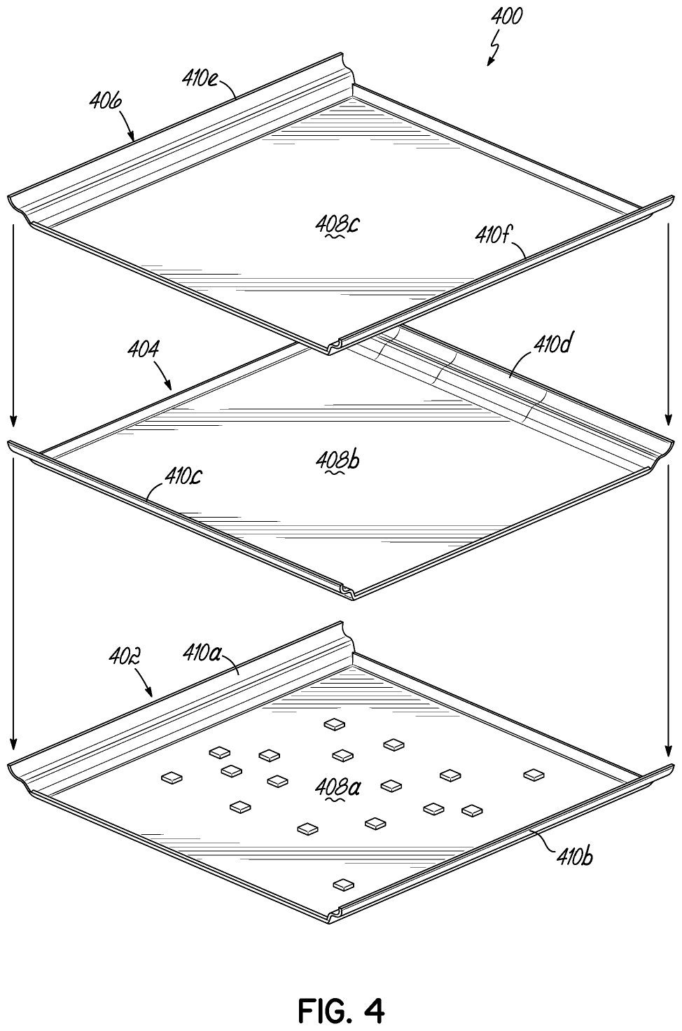

FIG. 4 is an isometric view 400 depicting an example of improved firing setters in a dis-assembled configuration, according to an embodiment. Setters 402, 404, and 406 are each made of YSZ and are ⅙ as thick and have an air gap that is ⅓ of that of setters 202, 204, and 206, of the example of FIG. 2, as described in greater detail below. The method of manufacturing setters 402, 404, and 406 is described in greater detail below. Setters 402, 404, and 406 are each constructed to have a flat rectangular section, 408a, 408b, and 408c, and a pair of rails, 410a, 410b, 410c, 410d, 410e, and 410f, on respective opposite sides of rectangular sections, 408a, 408b, and 408c.

Each of setters 402, 404, and 406 has dimensions 4.75 in×4.625 in (i.e., total area 21.97 in²). Each of setters 402, 404, and 406 has a usable area, 408a, 408b, and 408c, between rails 410a, 410b, 410c, 410d, 410e, and 410f, having dimensions 4.0 in×4.5 in (i.e., 18.00 in²) where objects to be fired may be placed. Each of setters 402, 404, and 406 weighs 70 g representing a total weight per total area of 31.19 g/in², and a weight per usable area of 3.89 g/in². Setters 402, 404, and 406 represent a substantial reduction in size and thermal mass relative to setters 102, 104, 114, 116, 126, and 128 of FIG. 1, as summarized in Table I., below.

TABLE I

| | setters 102 104 | | setters 114 116 | | setters 126 128 | | setters 402 404 | |
|---|---|---|---|---|---|---|---|---|
| | (zirconia) | | (alumina) | | (alumina) | | (zirconia) | |
| total size | 4.5 in × 2.375 in | | 4.5 in × 2.376 in | | 5.94 in × 5.875 in | | 4.75 in × 4.625 in | |
| total area | 10.69 | in² | 10.69 | in² | 34.90 | in² | 21.97 | in2 |
| useable size | 4.5 in × 1.875 in | | 4.5 in × 1.876 in | | 5.5 in × 5.25 in | | 4.0 in × 4.5 in | |
| useable area | 8.44 | in² | 8.44 | in² | 28.88 | in² | 18.00 | in² |
| weight | 180 | g | 128 | g | 307 | g | 70 | g |
| weight/total | 16.84 | g/in² | 11.98 | g/in² | 8.80 | g/in² | 3.19 | g/in² |
| area | | | | | | | | |
| weight/useable | 21.33 | g/in² | 15.17 | g/in² | 10.63 | g/in² | 3.89 | g/in² |
| area | | | | | | | | |

Setters 402, 404, and 406 have roughly 37% smaller mass per unit useable area and 36% smaller mass per total area relative to the heaviest setters (i.e., the 307 g alumina setters 126 and 128 of FIG. 1), and have roughly 26% smaller mass per unit useable area and 36% smaller mass per total area relative to the 26% smaller mass per unit total area relative to the lightest setters (i.e., the 128 g alumina setters 114 and 116 of FIG. 1). As described in greater detail below, setters 402, 404, and 406 have a thickness of approximately 0.03 in which is roughly ⅙ the thickness of the setters in FIGS. 1 and 2. Further, setters 402, 404, and 406 have a shape that allows an air gap between setters in a stacked configuration that is roughly ⅓ the gap of the setters of FIGS. 1 and 2, as described in further detail below.

As described above, improved setters 402, 404, and 406 are 0.03 in thick. Therefore, if a similar setter was constructed to have 0.02 in thickness the setter would have a weight to area ratio of approximately 2.1 g/in². This is a dramatic weight savings compared to the heaviest setter (e.g., setters 126 and 128 of FIG. 1). Such a new setter, having thickness of 0.02 in, would be roughly 90% lighter than the heaviest setter.

For at least two reasons, it may be difficult or impossible to reduce the mass of setters 102, 104, 114, 116, 126, and 128 (shown in FIG. 1, and summarized in Table I.) by reducing the thickness. A first reason is that setters 102, 104, 114, 116, 126, and 128 were made using processes of powder pressing or slip casting. Using powder pressing or slip casting, if the wall thickness is too thin, then various parts may break during manufacture. A second reason is that setters made of alumina (e.g., setters 114, 116, 126, and 128) have a substantial amount of air porosity. These setters are designed to have air porosity to reduce the mass, however, such porosity, while beneficial for lowering the mass, reduces the strength to the structure. Thus, attempts to make setters such as 102, 104, 114, 116, 126, and 128 much thinner may lead to mechanical failure during manufacturing and/or use.

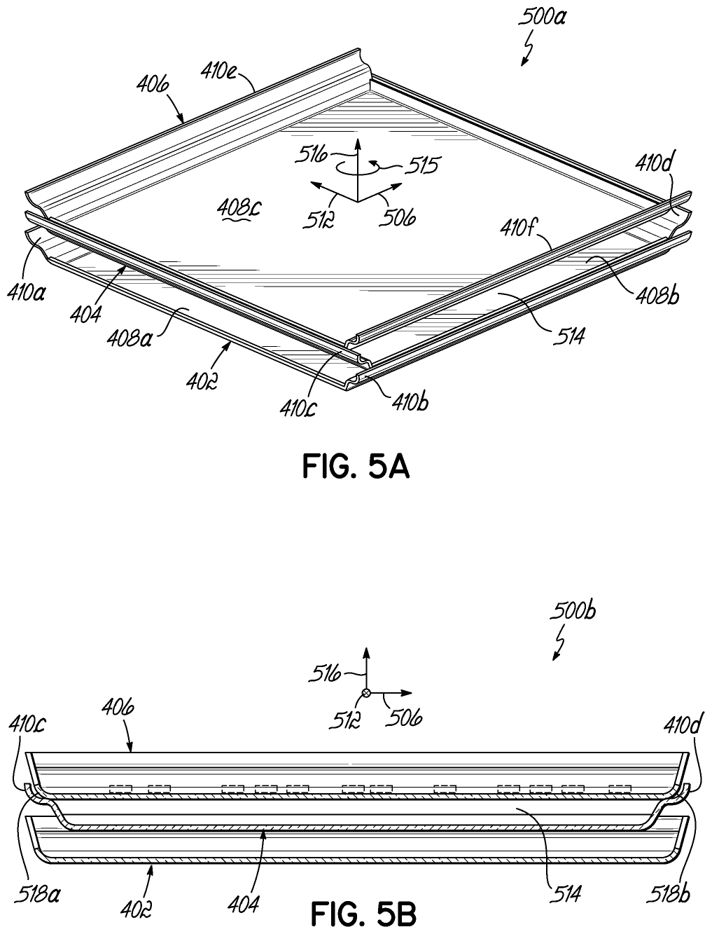

FIG. 5A illustrates a stacking configuration 500a of a plurality of improved firing setters similar to those of FIG. 4, according to an embodiment. In this example, setter 406 has rails 410e and 410f aligned along a first direction 506. Setter 406 is resting above setter 404 that has rails 410c and 410d that are aligned with a second direction 512 that is perpendicular to direction 506. As such, the rails 410e and 410f of setter 406, and the rails 410c and 410d of setter 404 are oriented so as to not rest above one another. In this configuration, an air gap 514 exists between setter 404 and setter 406. A smaller air gap would result if setters 404 and 406 were to be oriented so that the rails 410e and 410f of setter 406, and the rails 410c and 410d of setter 404 were positioned in alignment with one another. The relative alignment of setters 406 and 404 can be specified by an angle 515 of rotation relative to a third direction 516. In this example, setters 406 and 404 can be seen to be oriented relative to one another by 90°.

FIG. 5B is a cross sectional view 500b of the stacked setters of FIG. 5A, according to an embodiment. The cross section is taken along the direction 506 of FIG. 5A such that direction 512 points into the page and direction 516 points in a direction as shown. In this example, rails 410c and 410d of setter 404 are visible, while rails 410e and 410f of setter 406 are not visible in this view. As shown, bottom edges 518a and 518b of setter 406 rest on rails 410c and 410d of setter 404 respectively. This configuration provides the air gap 514 described above.

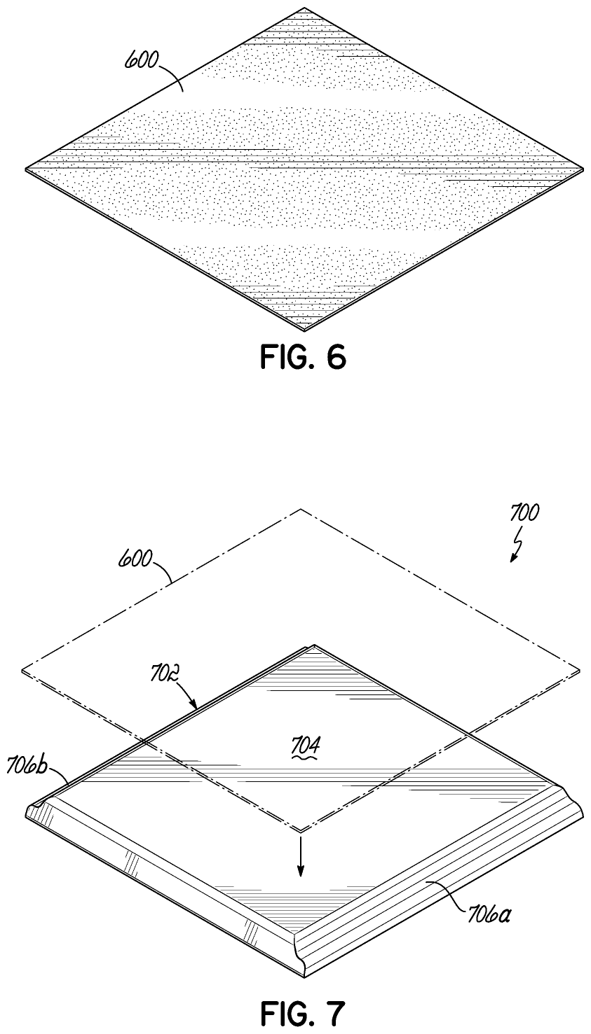

FIG. 6 illustrates a piece of ceramic tape 600 used in a method of manufacturing the improved setters of FIGS. 4 and 5, according to an embodiment. The ceramic tape is used with a form to mold a shape that is then sintered to form the improved setters, as described in greater detail below. According to an embodiment, the ceramic tape 600 may have ceramic particles embedded in a polymer (e.g., acrylic or vinyl). The ceramic particles may be chosen to be YSZ having a composition of zirconia that is stabilized with 3% yttria. Such ceramic tape may commercially obtained from Tosoh Inc. and is marketed under the name TZ3Y™. In other embodiments, the ceramic tape may include one or more of aluminum oxide, barium titanate, barium neodymium titanate, magnesium oxide, titanium oxide, calcium zirconate, and magnesium zirconate. For example, one or other ceramic material may be more cost effective or may have better compatibility with the ceramic materials to be fired. In some embodiments, a setter may be manufactured using a ceramic tape having a homogeneous blend of different ceramic particles. In further examples, setters may be manufactured using a layered blend of ceramic tapes having different compositions.

FIG. 7 is a perspective view 700 illustrating materials used in a method of manufacturing the improved setters of FIGS. 4 and 5, according to an embodiment. The materials include the above-described sheet of ceramic tape 600 and a form 702. The method includes placing one or more layers of ceramic tape 600 on the form 702 and applying pressure to the assembly that includes the form and the tape layers. The application of pressure to the assembly compresses the ceramic tape 600 layers together to generate an integrated body having a shape corresponding to the shape of the form 702. The furnace setter is then generated by removing the integrated body from the form 702 and applying a heat treatment to the integrated body to generate the furnace setter as a sintered solid body, as described in further detail below.

The form 702 is constructed to have a shape corresponding to a desired shape of the furnace setter, so that the resulting integrated body has a shape corresponding to the desired shape of the furnace setter. The form 702 has a flat rectangular section 704 that corresponds to flat rectangular sections, 408a, 408b, and 408c, respectively, of setters 402, 404, and 406 of FIG. 4. The form 702 includes curved features 706a and 706b on two opposite edges of flat rectangular section 704. The curved features 706a and 706b give rise to the pairs of rails, 410a, 410b, 410c, 410d, 410e, and 410f, on respective opposite sides of rectangular sections, 408a, 408b, and 408c, of setters 402, 404, and 406 of FIG. 4.

According to an embodiment, pressure may be applied to the assembly, which includes the form and the tape layers, using a high-pressure laminator. For example, the assembly may be placed inside a vacuum bag and sealed. The sealed bag may then be placed in the high-pressure laminator to compress the tape layers together to form the integrated body into the desired shape based on the shape of the form. The bag may then be removed from the high-pressure laminator and opened to remove the assembly that includes the form and the integrated body. The integrated body may then be removed from the form and heat treated to sinter the integrated body to generate the furnace setter as a solid body.

In further embodiments, the integrated body may be subjected a first heat treatment in a bake oven to remove polymer material. The integrated body may then be subjected to a second heat treatment in a furnace that sinters ceramic powders into the finished solid body. In further embodiments, a release material may be placed on the form before placement of layers of ceramic tape. Further, release material may be placed on a top surface of the layered material before pressure is applied.

According to an embodiment, the setter is sintered at a higher temperature than it is later used. This allows the ceramic of the setter to avoid creep and deformation during repeated cycles. In an example, the YSZ is sintered at 1340 C, and then the setter is used at 1240 C or less. Various YSZ formulations can be made to sinter at higher temperatures, up to 1450 C. Other ceramics like alumina and magnesia can also sinter at very high temperatures. Any problems with creep or deformation over time can also be overcome by making the setter thicker, as described below, depending on various factors such as the weight of the parts to be fired, the normal use temperature, the number of expected cycles, etc.

According to an embodiment, a setter may be manufactured using YSZ tape having a thickness of 0.002 in. One or more layers of ceramic tape 600 may be placed on the form 702 form to generate a layered material having thickness of 0.002 in, 0.004 in, etc. For example, placing 20 layers of ceramic tape 600 on the form 702 generates a layered material having thickness 0.04 in. Applying pressure generates an integrated body having a thickness that is somewhat reduced. Then, during sintering, the integrated body shrinks in three dimensions leading to a final thickness reduction of roughly 25% and a 20% reduction in a two-dimensional plane perpendicular to the thickness direction. Thus, an integrated body including 20 layers of ceramic tape 602, having thickness 0.04 in before firing, becomes a finished setter having thickness 0.03 in. Setters 402, 404, 406, 502, and 508, discussed above with reference to FIGS. 4 and 5, and table I., were manufactured in this way, as described in greater detail below.

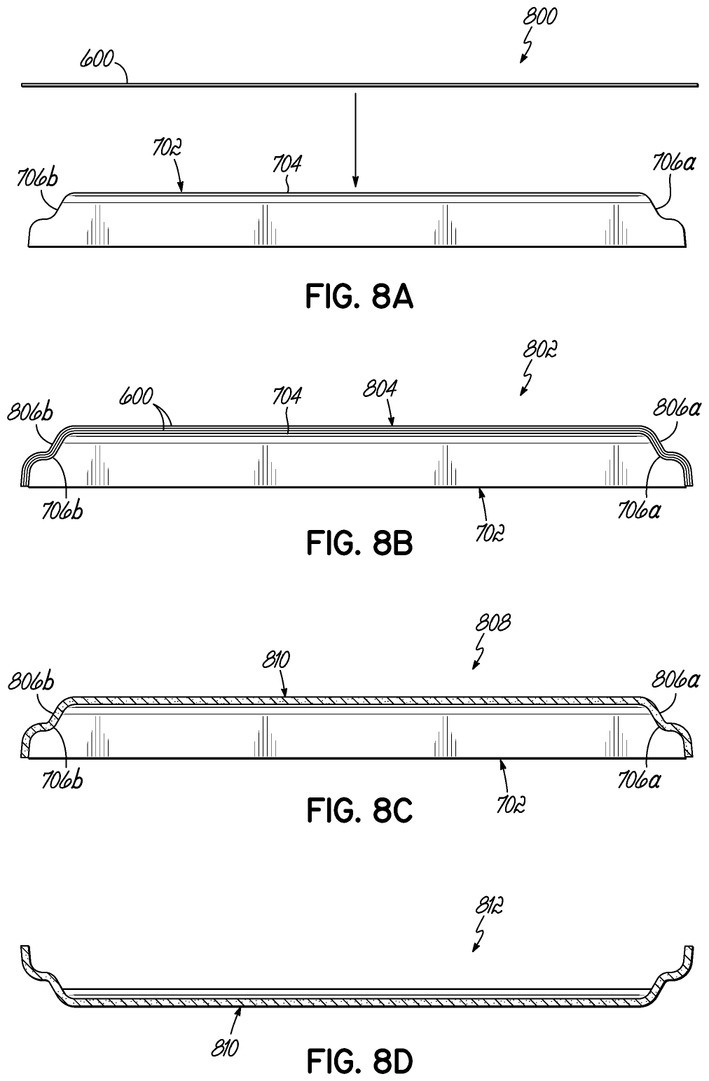

FIG. 8A is a cross sectional view 800 of a sheet of ceramic tape 600 and form 702 illustrated in FIG. 7, according to an embodiment. This cross-sectional view 800 clearly illustrates the curved features 706a and 706b that are on one pair of opposite sides of the rectangular flat section 704 of form 702. As described above, curved features 706a and 706b give rise to the pairs of rails, 410a, 410b, 410c, 410d, 410e, and 410f, on respective opposite sides of rectangular sections, 408a, 408b, and 408c, of setters 402, 404, and 406 of FIG. 4. One or more sheets of ceramic tape 600 are placed on the form 702 as shown in greater detail in FIG. 8B.

FIG. 8B is a cross sectional view 802 of a configuration in which several sheets of ceramic tape 600 are placed on the form 702, according to an embodiment. As shown, the sheets of ceramic tape 600 conform to the shape of the form 702. For example, the ceramic tape acquires a flat rectangular portion 804 as well as curved regions 806a and 806b corresponding to the curved features 706a and 706b of form 702. As described above, pressure is applied to the sheets of ceramic tape 600 to compress the sheets of ceramic tape 600 into an integrated body as illustrated in FIG. 8C below.

FIG. 8C is a cross sectional view 808 of a configuration in which pressure has been applied to sheets of ceramic tape on the form 702 to generate an integrated body 810, according to an embodiment. The integrated body 810 may then be removed from the form 710 and sintered.

FIG. 8D is a cross sectional view 812 of the resulting integrated body 810 that has been removed from the form 702, according to an embodiment. The integrated body 810 may then be sintered to generate an improved setter similar to those illustrated in FIGS. 4 and 5. During sintering, the integrated body shrinks in three dimensions leading to a final thickness reduction of roughly 25% and a 20% reduction in a two-dimensional plane perpendicular to the thickness direction. Thus, the resulting improved setter has a similar shape to the integrated body 810 with slightly reduced dimensions.

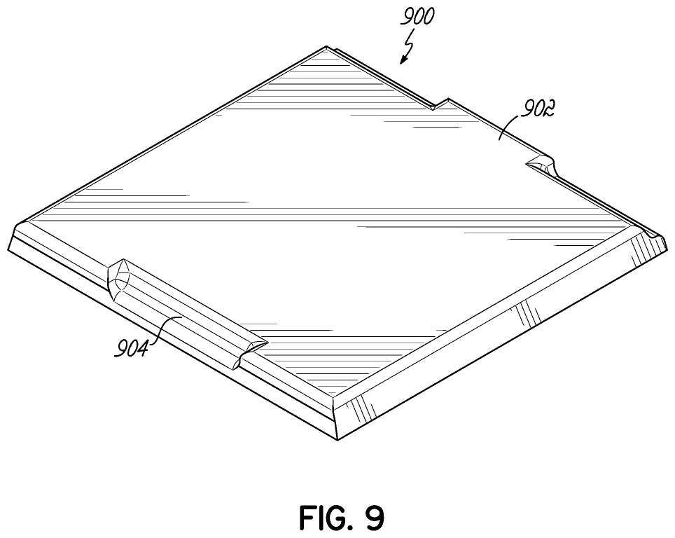

FIG. 9 shows a three-dimensional top-down view of a form 900 having different complementary features on opposite edges of a flat rectangular section, according to an embodiment. Form 900 has dissimilar features 902 and 904. As such, setters manufactured using form 900 have lower symmetry than setters 402, 404, 406, 502, and 508 that were manufactured based on form 700. In contrast to form 900, form 700 has two-fold symmetry about an axis that is perpendicular to the flat rectangular section 702. In other words, two setters generated from form 700 have two relative orientations.

Setters 406 and 404 in FIG. 5, for example, are oriented so that the rails 410e and 410f of setter 406 are aligned with direction 506, while the rails 410c and 410d are aligned with direction 512. Rotating one of the setters by 90° relative to axis 516 brings the rails of both setters into alignment. For example, rotating setter 406 by 90° would bring rails 410e and 410f of setter 406 into alignment with rails 410c and 410d of setter 404 along the axis 512. Similarly, a rotation of setter 404 by 90° would bring rails 410c and 410d of setter 404 into alignment with rails 410e and 410f of setter 406 along the axis 506. As described above, the relative orientations of setters 402, 404, and 406, resulting from the two-fold symmetry of setters 402, 404, and 406, enables air gaps having two selectable sizes depending on the relative orientation of the setters. A setter having lower symmetry provides three selectable air gap sizes as described in greater detail below.

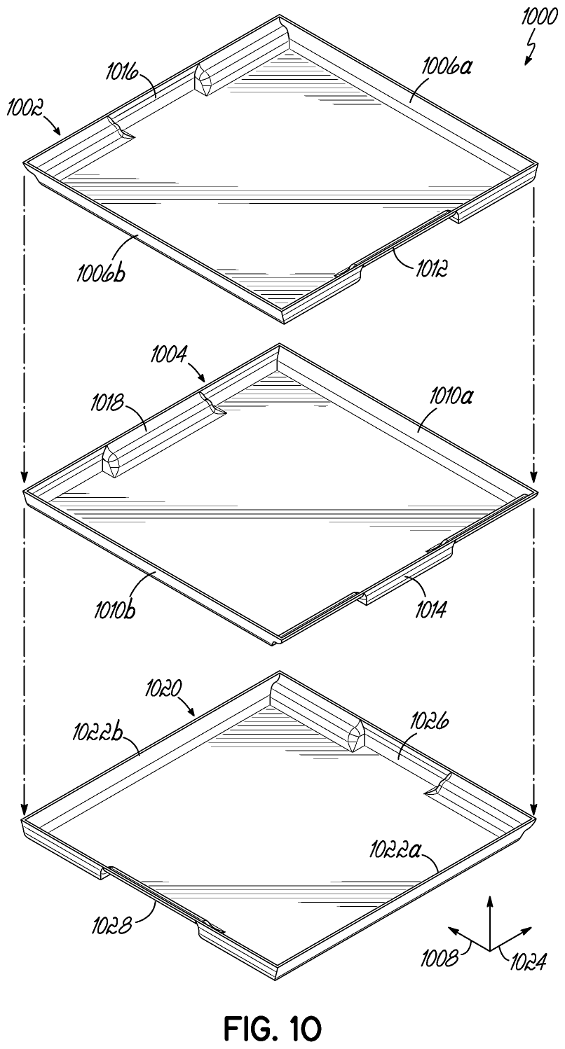

FIG. 10 illustrates a configuration 1000 in which setters based on form 900 of FIG. 9 may be arranged with three relative orientations, according to an embodiment. Setters 1002 and 1004 are shown having a relative orientation in which parallel edges 1006a and 1006b of setter 1002 are aligned with direction 1008. The edges 1010a and 1010b of setter 1004 are also shown as being aligned with direction 1008. In this example, there are two possible orientations of setters 1002 and 1004 such that edges 1006a and 1006b of setter 1002 are aligned with direction 1008 and edges 1010a and 1010b of setter 1004 are also shown as being aligned with direction 1008, as described in further detail below.

In the illustrated first orientation, a protrusion 1012 of setter 1002 is vertically aligned with an indentation 1014 of setter 1004. Similarly, an indentation 1016 of setter 1002 is vertically aligned with a protrusion 1018. A second orientation may be obtained by rotating one of setters 1002 and 1004 by 180° to bring protrusion 1012 of setter 1002 into alignment with protrusion 1018 of setter 1004 and to bring indentation 1016 of setter 1002 into alignment with indentation 1014 of setter 1004.

A third relative orientation of setters 1002 and 1004 may be obtained by rotating one of setters 1002 and 1004 by 90° with respect to the other. For example, setter 1020 is shown in a configuration in which opposite edges 1022a and 1022b are aligned along direction 1024. In this configuration, indentation 1026 and protrusion 1028 are aligned with straight edges 1010a and 1010b of setter 1004, respectively. The situation is essentially unchanged if setter 1020 were to be rotated by 180° because in that situation, the indentation 1018 and protrusion 1014 of setter 1004 are still engaged with the straight edges 1022a and 1022b of setter 1020. Similarly, the indentation 1026 and protrusion 1028 of setter 1020 would be aligned with straight edges 1010a and 1010b of setter 1014 after rotation by 180°. The air gap between setters is determined by the way features (i.e., indentations, protrusions, and straight edges) are aligned vertically. As such, there are essentially only three relative orientations shown in FIG. 10 that produce three respective air gaps. In an example, the setters based on form 900 may be manufactured to have three selectable air gaps having values 0.02 in, 0.08 in, and 0.16 in. In other embodiment, setters may be manufactured having selectable air gaps taking on other values.

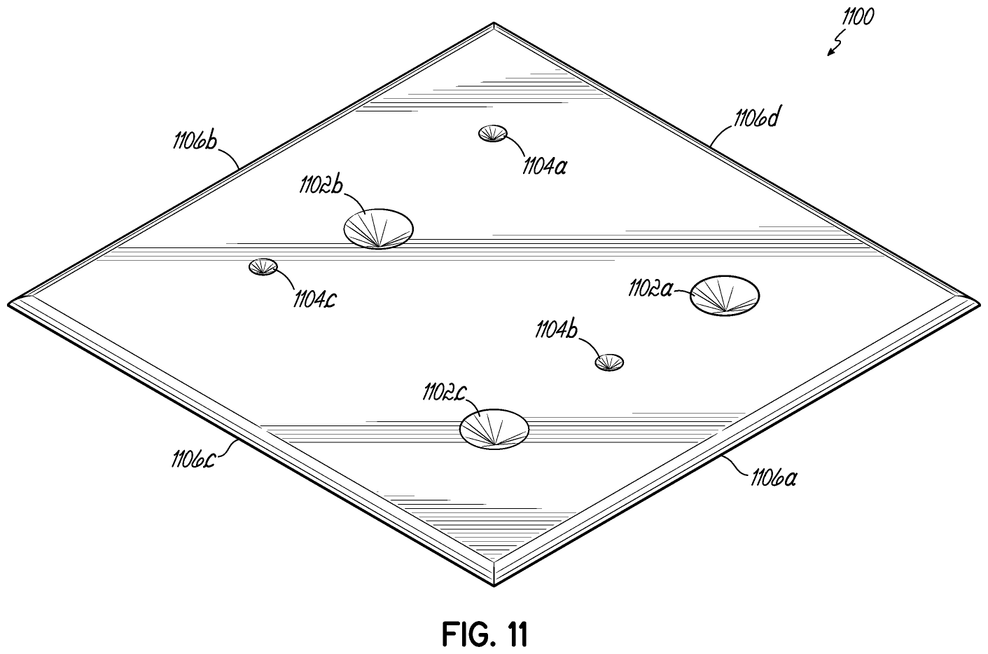

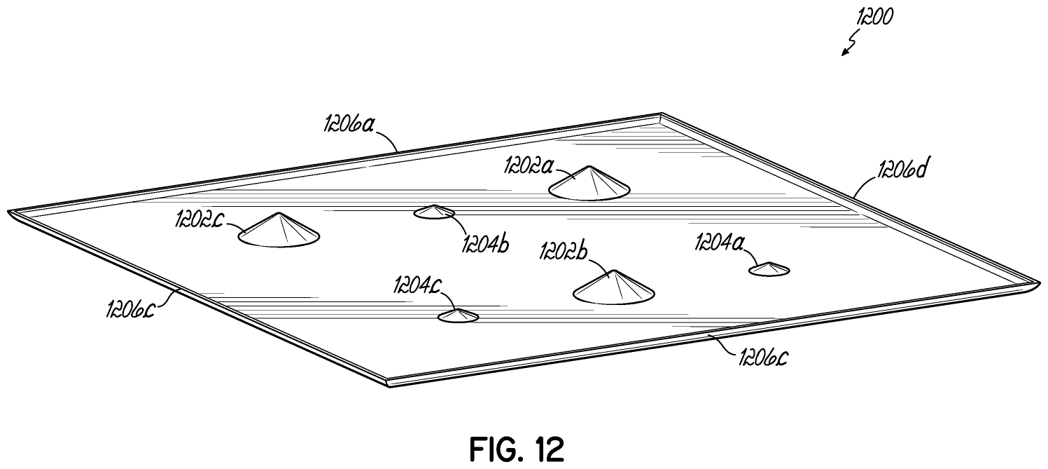

FIG. 11 shows a three-dimensional top-down view of a form 1100 having six features, according to an embodiment. The form 1100 has three large conically shaped depressions 1102a, 1102b, and 1102c. The form 1100 also has three small conically shaped depressions 1104a, 1104b, and 1104c. Form 1100 also has a first pair of edges, 1106a and 1106b, on a first pair of opposite sides of the form 1100. The form also has a second pair of edges, 1106c and 1106d, on a second pair of opposite sides of the form 1100. Setters manufactured using form 1100 have edges corresponding to edges 1106a, 1106b, 1106c, and 1106d, and raised features corresponding to depressions 1102a, 1102b, 1102c, 1104a, 1104b, and 1104c, as described in greater detail below, with reference to FIG. 12.

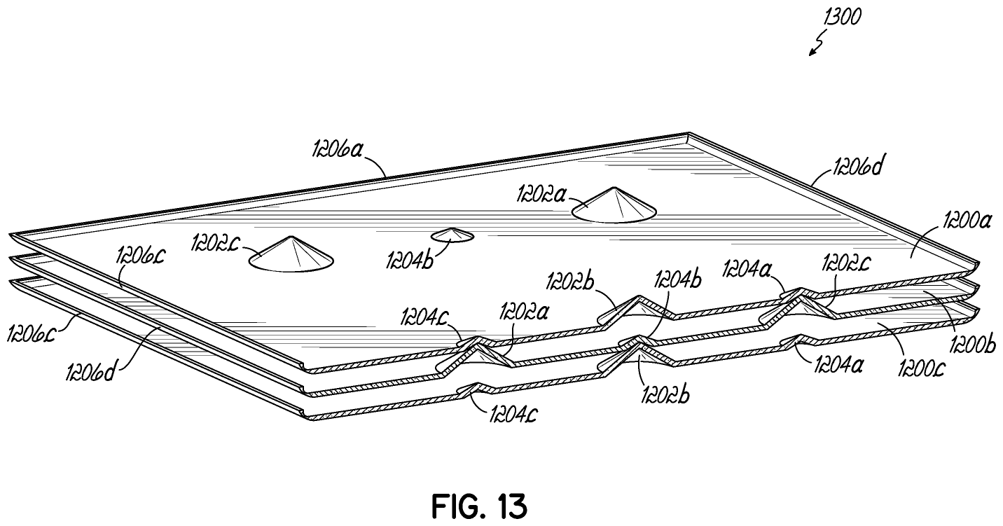

FIG. 12 shows a three-dimensional top-down view of a setter 1200 manufactured based on the form of FIG. 11, according to an embodiment. Setter 1200 has large conically shaped raised features, 1202a, 1202b, and 1202c, corresponding to depressions 1102a, 1102b, and 1102c, of form 1100. Setter 1200 also has small conically shaped raised features, 1204a, 1204b, and 1204c, corresponding to depressions 1104a, 1104b, and 1104c, of form 1100. Setter 1200 also has a first pair of edges, 1206a and 1206b, corresponding to edges, 1106a and 1106b, of form 1100. Setter 1200 also has second pair of edges, 1206c and 1206d, corresponding to edges, 1106c and 1106d, of form 1100. Raised features 1202a, 1202b, 1202c, 1204a, 1204b, and 1204c, act as spacers to give a vertical separation between a plurality of stacked setters, as described in greater detail below with respect to FIG. 13.

FIG. 13 illustrates a three-dimensional top-down cross-sectional view of a configuration 1300 in which setters based on form 1100 of FIG. 11 are arranged in a stacked configuration with a vertical gap between setters, according to an embodiment. In this example, three setters 1200a, 1200b, and 1200c, are shown. The cross-sectional view is taken as a slice that cuts through three conically shaped raised features of each of the setters 1200a, 1200b, and 1200c. The setters are shown in an orientation in which every other setter (e.g., 1200a and 1200c) have a common orientation. For example, small raised features, 1204a and 1204c, of the top setter 1200a, are aligned with corresponding small raised features, 1204a and 1204c, of the bottom setter 1200c. Similarly, large raised feature 1202b of the top setter 1200a is aligned with the corresponding large raised feature 1202b of the bottom setter, 1200c.

In this example, the middle setter 1200b has an orientation that is rotated by 180° in the two-dimensional plane of the setter 1200b relative to setters 1200a and 1200b. In this configuration, large raised feature 1202a of setter 1200b is aligned with small features 1204c of setters 1200a and 1200c. Similarly, large raised feature 1202c of setter 1200b is aligned with small raised features 1204a of setters 1200a and 1200c. In this configuration, the large raised features on one setter (e.g., raised features 1202a and 1202b of setter 1200b) are placed in a locking arrangement with depressions on the underside of a setter above (e.g., depressions corresponding to small raised features 1204a and 1204c of setter 1200a). Similarly, the large raised feature 1202b of setter 1200c is placed in a locking arrangement with a depression corresponding to small raised feature 1204 of middle setter 1200b. In this way, the various large raised features of a given setter are placed in locking arrangement with corresponding depressions on the underside of a setter above. In this example, the corresponding depressions on the underside of a setter above correspond to the small raised features of the setter placed above. In this way, the raised features 1202a, 1202b, 1202c, 1204a, 1204b, and 1204c, of the various setters, act as spacers to give a vertical separation between a plurality of stacked setters. In this configuration, the edges 1206a, 1206b, 1206c, and 1206d, play no role in providing vertical separation to the stacked setters, in contrast to the example of FIG. 10 in which the edges (rails) provided vertical separation.

While there are six raised features (i.e., poles, pillars, or bumps), the three tall ones (e.g., raised features 1202a, 1202b, and 1202c) provide the standoff (i.e., vertical separation) to the setter above, and the three short ones (e.g., 1204a, 1204b, and 1204c) provide a receptacle (on the underside) so that the setters on top does not slide by forming locking engagement between tall features on a given setter with corresponding receptacles on the above-neighboring setter. In other embodiments, other numbers of raised features may be employed. There is an advantage of having the pillars in the center of the setter providing vertical support, as opposed to vertical support being provided by the rails near the edges, as in the example of FIG. 10.

In the example of FIGS. 11-13, the span between support areas is lower for configurations based on raised features, in contrast to configurations based on rails that provide support, as was the case in the example of FIG. 10. For example, on a 5-inch square setter with rails at the edges, the span of unsupported ceramic is about 5 inches. During repeated firings at high temperature, the center of the setter may tend to sag. On a 5-inch setter with 3 pillars, the span would be less. Because the pillars are in a triangle in our example, the span is estimated to be about ⅓ of 5 inches, or about 1.5 inches. Sagging during repeated cycles would be reduced.

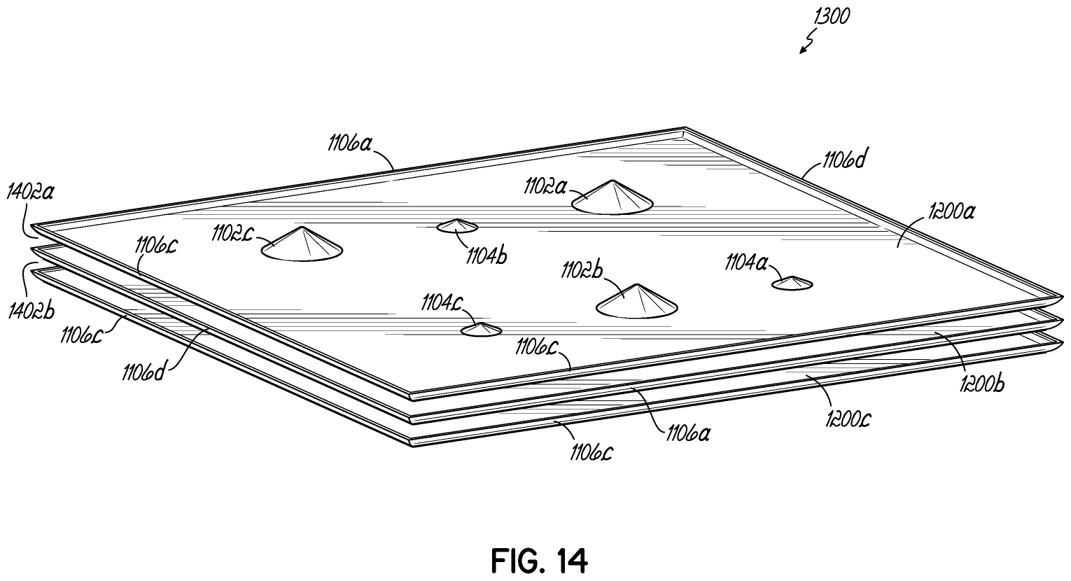

FIG. 14 illustrates a three-dimensional top-down view of a stacked configuration of setters based on the form 1100 of FIG. 11, according to an embodiment. In this example, setters 1200a, 1200b, and 1200c are stacked as described above with reference to FIG. 13. The raised features 1202a, 1202b, 1202c, 1204a, 1204b, and 1204c of the top setter 1200a are clearly seen but similar features 1202a, 1202b, 1202c, 1204a, 1204b, and 1204c of setters 1200b and 1200c cannot be seen in this view. As described above, the relative orientation of setter 1200a and 1200c are the same, whereas, setter 1200b is rotated by 180° relative to setters 1200a and 1200c. As described above, this relative orientation of setters 1200a, 1200b, and 1200c, allows the raised features 1202a, 1202b, 1202c, 1204a, 1204b, and 1204c to be placed in cooperative alignment to generate vertical separation gaps 1402a and 1402b. As shown, a gap 1402a is generated between setters 1200a and 1200b, and a gap 1402b is generated between setters 1200b and 1200c.

In further embodiments, the vertical support strategies of FIG. 10, based on rails, can be combined the vertical support strategy of FIGS. 11-14 based on raised features. For example, support may be provided by rails as opposite edges of a setter along with additional support being provided one or more raised features in an interior location on a surface of a setter. For example, a setter may have two oppositely placed supporting rails and a single raised feature at the center of the setter. In further embodiments, support may be provided by first and second pairs of opposite rails along with one or more raised features on the surface of a setter.

During use, all raised features on a given setter would be pointing in an upward direction away from the setter surface. Small objects to be heat treated would then be placed on the setter without the possibility of a small object falling into a depression on the surface. As such, setters such as those described with reference to FIGS. 11-14 may be easily stacked after objects have been loaded on the setters. In some embodiments, setters such as those illustrated in FIGS. 11-4 may be used to heat treat ceramic capacitors that have a thickness of 0.010 inches. For this application, a setter may be designed to have rails around the edges of all four sides that are about 0.020″ high. In addition, the setters may also include a raised feature in the center of the setter that is roughly 0.025 inches thick.

Further embodiments may include many raised features, spaced on a grid of 0.5 inches or 1.0 inches (e.g., having 25 to 100 raised features in a grid). The setter might have a web thickness that is only 0.015 inches thick. In this way, the following goals may be achieved: low mass and short vertical distance from setter to setter, side rails for easy loading without spilling over the edges, and raised features that give proper vertical spacing for the parts to be heat treated, while preventing sagging due to creep during sintering. In further embodiments, the smaller raised features (e.g., features 1204a, 1204b, and 1204c) may be eliminated.

The above-described embodiments related to rectangular firing setters. However, firing setters may be generated having any convenient shape. For example, a setter having a circular shape may be used to heat treat ceramic parts having a round/circular geometry. In other embodiments, triangular setters may be used. Triangular setters may be useful based on the observation that three points touching prevent an item from rocking. A triangular setter may have three raised features (or pillars), one at each corner, and then short rails around all three sides. Square setters give better packing in a furnace, but sometimes the important issue is heat transfer from the walls of the furnace to the center of the load. The higher density of the packing on these advanced setters would make it worthwhile to have triangular setters, so that the heat can penetrate the stacks.

In a typical firing operation, there are multiple stacks of setters being fired in a single furnace. In some operation, four or six stacks of setters, depending on sizes, may be used. In the example of four stacks being fired, this gives the challenge that stacks have two faces that are oriented facing the heating elements and two faces that are not facing heating elements. Or in the case of six stacks of setters, in a 2×3 arrangement on the floor of a furnace, there would be two stacks that only have one face of the setter that faces the heating elements. Thus, heat transfer considerations may make different shaped setters useful in the interest of allowing heat to transfer quickly to the center of the load that includes multiple stacks of setters.

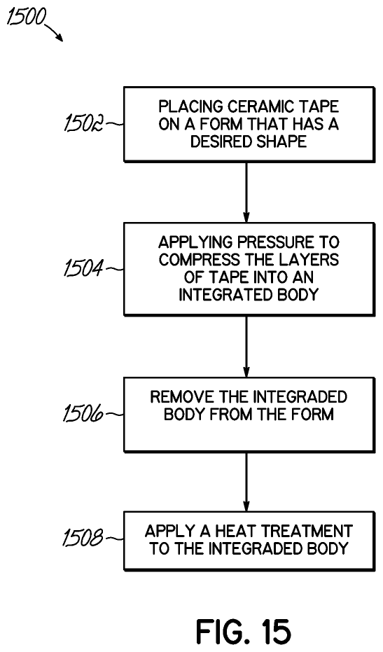

FIG. 15 is a flowchart illustrating a method 1500 of manufacturing an improved furnace setter, according to an embodiment. In stage 1502, the method includes placing one or more layers of ceramic tape on a form, which has a shape corresponding to a desired shape of the furnace setter, to thereby generate an assembly. In stage 1504, the method includes applying pressure to the assembly to compress the ceramic tape layers together to generate an integrated body having the desired shape of the furnace setter. Stage 1506 includes removing the integrated body from the form, and stage 1508 includes applying a heat treatment to the integrated body to generate the furnace setter as a sintered solid body. In further embodiments, the method may further include generating the furnace setter to have a shape comprising a thickness profile having a center region of the rectangular section that is thinner than edge regions of the setter.

One advantage of the disclosed improved furnace setters is that the mass may be reduced by making the setters very thin. This lowers the load of the furnace, and allows it to heat up with less power consumption. Also, lower mass means that the furnace will equalize the temperature in a shorter time, giving better uniformity and quality. Also, lower mass means that the furnace can be made to heat up faster and cool down faster, thereby allowing higher utilization of the furnace (more cycles per week or per year).

Another advantage of the new setter is that the spacing between the parts may be closer in the vertical direction, so that more setters can be put into the furnace. For example, if the old setters (e.g., setters 102, 104, 114, 116, 126, and 128 of FIG. 1) allowed 15 setters high within the height of a furnace, the new setters could allow 30, 60 or even 120 setters high in the furnace. This is because the old setters frequently had a web thickness (web is a common term for the center of a carrier) of 0.200 in, but the new setter can have a web thickness as small as 0.020 in. Setters have been manufactured that have a web thickness of 0.030 in. Other thicknesses that are greater or less than 0.030 in are also possible. A web thickness may be chosen to be as thin as 0.010 in or lower, or it may be chosen to be 0.100 in or thicker. The exact choice may depend upon the exact size and shape desired in the final setter, and the weight of the components to be fired.

In addition, the spacing of the setters depends on the thickness of the components being fired, and the amount of space desired above the component. For example, for small capacitors, (e.g., the “0201 capacitor” from Devoe Inc.) which have a thickness of 0.010 in per chip, a setter with a web thickness of 0.020 in, a chip thickness of 0.010 in, and an air gap of 0.02 in would be desirable. In total this equals 0.050 in total height, so 20 setters could be fit into a one-inch high space. Compared to a normal setter that has 0.5 in high rails (or two setters per inch in height), these new setters allow 10 times more per inch.

Because of the way that the setter is made, it is possible to easily emboss shapes into the setter. For example, it is possible to put in short or tall walls that would keep parts separate. Further embodiments may include embossed numbers or codes placed in pockets to help keep parts organized. This can be useful at a company that is firing discrete jobs where each part is different. An example of a company that needs such a setter is a company making ceramic teeth for the dental industry, where each job has been exactly fitted to the patient's real tooth. In addition, it is possible to put part numbers along the rails of the setter, for example, to keep track of which setter is associated with which product material. The embossing of shapes/contours into the setter, such as walls, dividers, pockets, numbers, may be accomplished by putting corresponding shapes into the form used at lamination. The desired shapes would then be transferred into the ceramic setter by the pressure forces.

The disclosed setters are made with fine grained ceramic, and by nature they are quite smooth. This has an advantage when firing capacitors in that it allows the capacitors to spread out quickly on the setter. In this example method, a small pile of capacitors placed in the center of the setter may easily be distributed by shaking the setter lightly using a side to side motion. The shaking spreads out the capacitors in a mono-layer, as desired. This makes the new setter easier and faster to load than known setters. In contrast, the known setters are made with coarse grained ceramic, so they have higher surface friction. However, the coarse-grained ceramics are sometimes cheaper, which is one reason to use them as needed.

If a rough surface is desired, it is possible to emboss some texture onto the surface. One reason to do this would be to have less surface contact to the component to be fired. Lower contact might reduce chemical interaction, or it might lower the rate of sticking, or it might allow oxygen or other gas to contact the bottom side of the component. It is possible to emboss many shapes into the surface of the setter. Possible shapes may include points on a grid, rounded mounds, u-shaped channels, cup shape divots, etc.

In further embodiments, the top surface of the setter may be a different composition than the rest of the setter. For example, setters have been made using YSZ thickness of 0.028 in as the primary material with a top layer having a composition of barium neodymium titanate (BNT) having 0.002 in thickness. This configuration may be desirable because BNT capacitors were found to stick to the YSZ. However, putting a thin layer of BNT tape onto the surface of the setter during manufacturing (so that it was fired on in an integrated way) alleviated the problem of capacitors sticking to the setter. In further embodiments, the surface layer may be made using any ceramic type that provides compatibility with the parts being sintered on the setter. In such a structure, the interior of the setter provides strength, and the exterior surface provides chemical compatibility

In addition, one layer of BNT on the surface of the setter caused the setter to warp when it was originally sintered. Placing a layer of BNT on the back side of the setter created a symmetric structure that alleviated the problem of the setter warping during sintering. In some embodiments, a low purity ceramic may be used in the center of the setter, and then a high purity ceramic may be used on the surface of the setter. Such structures may be manufactured using ceramic tape having less expensive or lower purity powder in the center of the structure along with a more expensive or higher purity ceramic tape on the surface.

Because setters are manufactured using multiple layers of ceramic tape, it is possible to make setters that are thin near the web (i.e., in the center of the setter) while making them thicker at the edges, where the rails are. This may allow a tall stack of setters to carry a higher load through the rails, down to the base of the setter stack.

In further embodiments, other shapes may be manufactured using the disclosed methods. For example, a crucible may be manufactured by placing layers of ceramic tape over a form having a rounded shape. The resulting assembly may be laminated to compress the layers of tape to form an integrated body, as described above. The integrated body may then be removed from the form and may be subjected to a heat treatment to sinter the integrated body into the final solid body forming the crucible.

While various aspects in accordance with the principles of the invention have been illustrated by the description of various embodiments, and while the embodiments have been described in considerable detail, they are not intended to restrict or in any way limit the scope of the invention to such detail. The various features shown and described herein may be used alone or in any combination. Additional advantages and modifications will readily appear to those skilled in the art. The invention in its broader aspects is therefore not limited to the specific details and representative devices shown and described. Accordingly, departures may be made from such details without departing from the scope of the general inventive concept.

1.-12. (canceled)

13. A furnace setter, comprising:
a weight to area ratio that is less than 10 g/in² over the entire volume of the furnace setter.

14. The furnace setter of claim 13, further comprising:
a thickness that is less than or equal to 0.03 inches.

15. The furnace setter of claim 13, further comprising one or more of yttria stabilized zirconia, aluminum oxide, barium titanate, barium neodymium titanate, magnesium oxide, titanium oxide, calcium zirconate, and magnesium zirconate.

16. The furnace setter of claim 13, further comprising:
a shape that enables two or more setters to be stacked in a first relative orientation, having a first separation between stacked setters, and a second relative orientation, having a second separation between stacked setters.

17. The furnace setter of claim 16, further comprising:
a shape comprising a flat rectangular section comprising rails on at least one pair of opposite sides of the rectangular section.

18. The furnace setter of claim 17, further comprising:
a shape comprising complementary features in the rails that enable two or more setters to be stacked in first, second, and third relative orientations, having corresponding first, second, and third separations between stacked setters.

19. The furnace setter of claim 13, further comprising:
a shape comprising a thickness profile having a center region of the rectangular section that is thinner than edge regions of the setter.

20. A furnace setter, comprising:
a base material of yttria stabilized zirconia having a thickness less than or equal to 0.03 inches over the entire furnace setter; and
a coating material having thickness less than or equal to 0.002 inches over the entire furnace setter and comprising one or more of aluminum oxide, barium titanate, barium neodymium titanate, magnesium oxide, titanium oxide, calcium zirconate, and magnesium zirconate.
